(19) United States
(12) Patent Application Publication
(10) Pub. No.: US 2015/0178035 A1
(43) Pub. Date: Jun. 25, 2015

(54) SMART PHONE/TABLET COMPUTER DISPLAYABLE AND OPERABLE ON FRONT AND REAR SIDES OR MULTIPLE SIDES

(71) Applicants: Jyh-Yi Loo, New Taipei City (TW); Cheng-Jung Lee, New Taipei City (TW)

(72) Inventors: Jyh-Yi Loo, New Taipei City (TW); Cheng-Jung Lee, New Taipei City (TW)

(21) Appl. No.: 14/591,005

(22) Filed: Jan. 7, 2015

Related U.S. Application Data
(63) Continuation-in-part of application No. 13/693,057, filed on Dec. 4, 2012, now abandoned.

(30) Foreign Application Priority Data
Apr. 27, 2012 (TW) 101207990

(51) Int. Cl. G06F 3/14; G09G 5/02; G06F 1/16; G06F 3/147

(52) U.S. Cl. CPC G06F 3/1431; G06F 3/147; G09G 5/02; G06F 1/1618; G06F 1/1626; G06F 1/1647; G09G 2360/04; G09G 2320/0666

(57) ABSTRACT

Disclosed is a smart phone/tablet computer capable of displaying and operation on front and rear sides or on multiple sides, including a main body. The main body has a front side and a rear side that are respectively provided with a first displaying/operating unit and a second displaying/operating unit. The main body has a further side electrically connected to at least one third displaying/operating unit. The main body includes a control unit, which enables a signal to displaying, in a synchronous or non-synchronous manner, on each of the first, second, and third displaying/operating units. The control unit includes an image processing section and at least one detachable third displaying/operating unit electrically connected thereto. After a signal has been processed by the image processing section, the first displaying/operating unit, the second displaying/operating unit, and the third displaying/operating unit are enabled to displaying one of a color signal and a grey-scale signal.

### CROSS-REFERENCE TO RELATED APPLICATION

This is a continuation-in-part of co-pending U.S. patent application Ser. No. 13/693,057 filed on Dec. 4, 2012 and owned by the present applicant.

### (a) TECHNICAL FIELD OF THE INVENTION

The present invention generally relates to a smart phone/tablet computer that is displayable and operable on both front and rear sides or on multiple sides, and more particularly to an electronic device that combines a backlighting color display mode and a reflective display mode and provides synchronous and non-synchronous display modes.

### (b) DESCRIPTION OF THE PRIOR ART

The fast progress and advancing of electronic communication technology brings diversified portable electronic devices, such as smart phones, personal digital assistants, electronic books, tablet computers, and compact and lightweight hand-held computers, that enrich and satisfy daily needs of general consumers. Particularly, these devices involve additional displaying functions for texts, pictures, and images, making them prevailing and popular for the convenience of use.

However, most of the display function included portable electronic devices available in the market involve the use of a highly power consuming backlighting color display. Watching such a display for a long period of time often causes damage to the eyesight and the high brightness blue and white light components contained in the color light source of backlighting are of more concern in this respect. Further, such devices suffer being hard to read in a condition of being directly irradiated by outdoor light or sunlight.

In addition, a conventional smart phone has a single display operation unit, making it incapable of meeting the needs of applications of multiple displaying, and only a single display of a single material or mode being involved. Consequently, problems such as excessively large data flow, network jamming, delay, or even interruption may result. This may cause additional cost and expense. Apparently, the conventional portable electronic device may require further improvement in respect of displaying technology involved.

### SUMMARY OF THE INVENTION

The primary object of the present invention is to provide a smart phone/tablet computer that is displayable and operable on both front and rear sides or on multiple sides, wherein diversification of application thereof can be reached through an arrangement of displaying on both sides and operations through touch control achievable on both sides.

To achieve the above object, the present invention provides a front-and-rear-side or multiple-side displayable and operable smart phone/tablet computer that comprises a smart phone or a tablet computer that is capable of displaying and operation on front and rear sides or on multiple sides thereof and comprises a main body. The main body has a front side and a rear side that are respectively provided with a first displaying/operating unit and a second displaying/operating unit. The main body has a further side electrically connected to at least one third displaying/operating unit. The main body comprises a control unit by which a signal can be displayed, in a synchronous or non-synchronous manner, on each of the first, second, and third displaying/operating unit. The control unit further comprises an image processing section and at least one detachable third displaying/operating unit electrically connected thereto. After a signal has been processed by the image processing section, the first displaying/operating unit, the second displaying/operating unit, and the third displaying/operating unit are enabled to displaying one of a color signal and a grey-scale signal.

The displaying/operating units of the present invention can be a backlighting electronic display or a reflective electronic display, wherein a non-synchronous display mode is such that the first displaying/operating unit and the second displaying/operating unit each individually display a signal in processing, while the synchronous display mode is such that the first displaying/operating unit and the second displaying/operating unit synchronously display a signal in processing.

With the above solution, compared to a conventional portable electronic device that involves a single backlighting color display, the present invention allows a user to alternatively select displaying in a gray scale manner so as to overcome the problems of excessively large data flow, network jamming, delay, and interruption and also to reduce power consumption. Further, the present invention allows for diversified applications of synchronous and non-synchronous use through the main body being provided with displays on two sides and allowing for touch control to be achieved in the two sides, together with an expansion to multiple screens (an electronic paper) through an additionally attached manner, where each of the electronic papers may each and further comprise a function of displaying and operation on opposite sides thereby effectively alleviating the shortcomings of the prior art devices.

Further, the present invention may help eliminate a digital gap for remote and poverty areas, save electrical power, and replace, to a substantial extent, paper-made textbooks and reference books to achieve protection of forest and reduction of carbon.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic plan view showing a first embodiment of the present invention.

FIG. 2 is a block diagram illustrating a hardware architecture of the present invention.

FIG. 3 is a side elevational view of the present invention, together with an enlarged view of a circled portion thereof.

FIG. 4 is a perspective view showing a second embodiment of the present invention.

FIG. 5 is also a perspective view similar to FIG. 4, but taken from a different angle.

FIG. 6 is an exploded view of the second embodiment of the present invention.

FIG. 7 is a perspective view showing a third embodiment of the present invention.

FIG. 8 is a perspective view showing a folded condition of the device of FIG. 7.

FIG. 9 is a perspective view showing another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

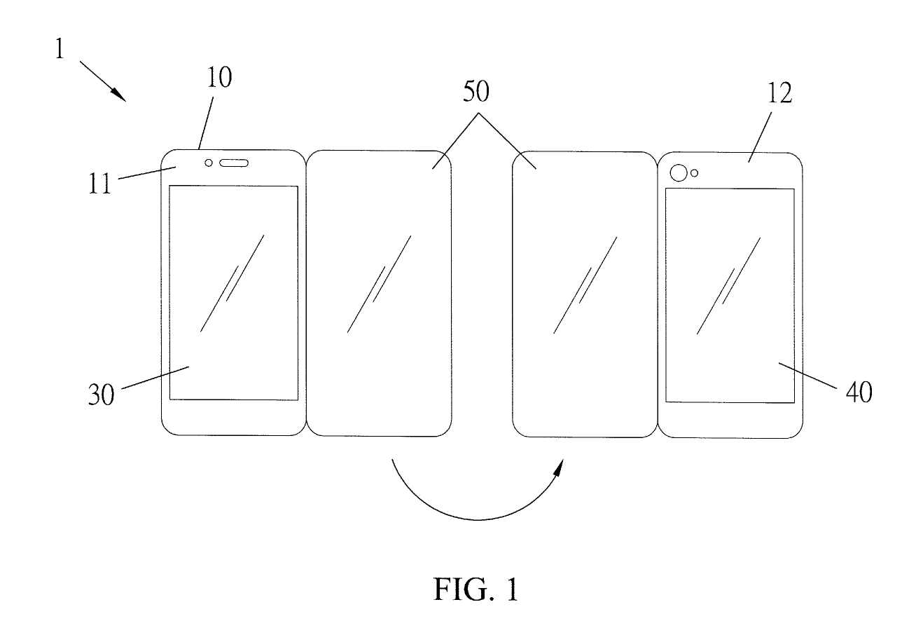

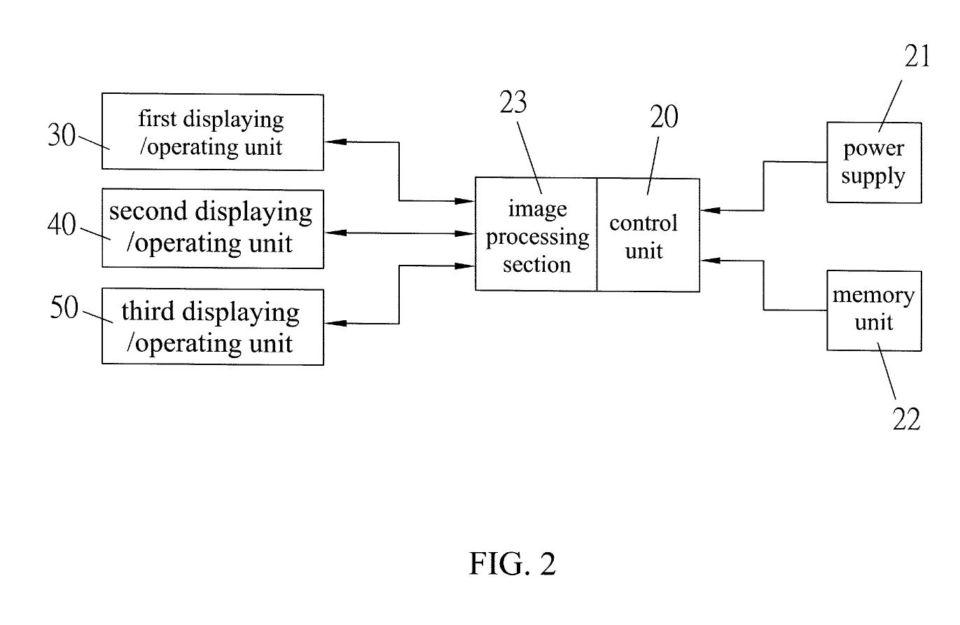

Referring to FIGS. 1-3, the present invention provides a smart phone/tablet computer 1 that is capable of displaying and operation on both front and rear sides or on multiple sides, comprising a main body 10, a control unit 20, a first displaying/operating unit 30, a second displaying/operating unit 40, and a third displaying/operating unit 50.

The main body 10 comprises a front side 11 and a rear side 12. The first displaying/operating unit 30 is mounted to the front side 11 of the main body 10. The second displaying/operating unit 40 is mounted to the rear side 12 of the main body 1.

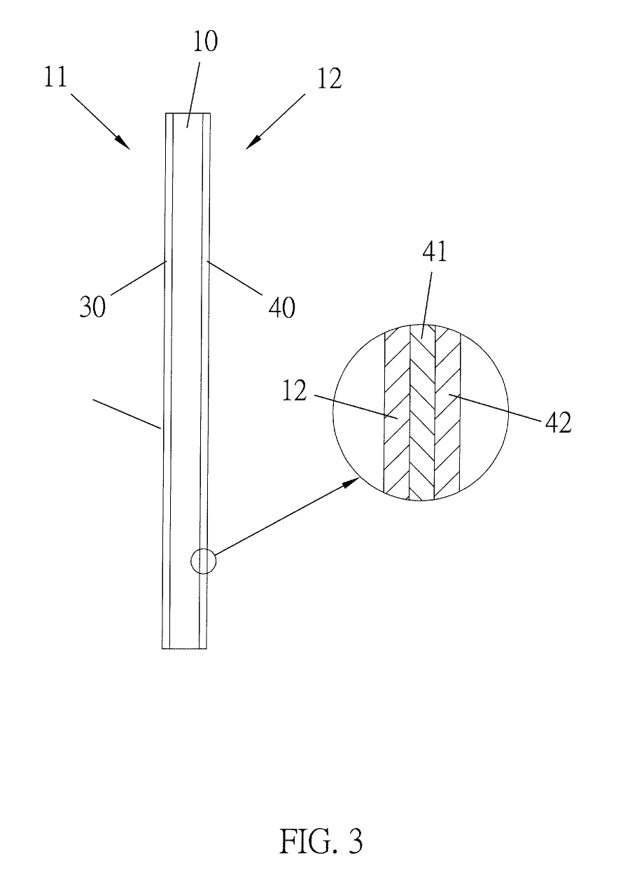

Referring to FIG. 3, in the instant embodiment, the first displaying/operating unit 30 is a conventional liquid crystal display screen, which displays a color signal, while the second displaying/operating unit 40 is an electronic paper 41, which displays a grey-scale signal. The electronic paper 41 is attached to the rear side 12 of the main body 1 and is further covered with a protective film 42 that is formed of touch control glass or plastics to provide a display screen that is light, thin, and power saving.

The first displaying/operating unit 30 can be a touch control screen, which can be a backlighting electronic display, a reflective electronic display, or a self-luminous electronic display (such as an organic light-emitting diode, OLED), which allows for direct input of an operation signal.

The control unit 20 is arranged inside the main body 1 and is electrically connected to a power supply 21 and a memory unit 22. The power supply 21 supplies electrical power and the memory unit 22 stores data.

The control unit 20 comprises therein an image processing section 23 and at least one detachable third displaying/operating unit 50 electrically connected thereto.

The control unit 20 is electrically connected to the first displaying/operating unit 30, the second displaying/operating unit 40, and the third displaying/operating unit 50 for transmission of signals and switching the first displaying/operating unit 30, the second displaying/operating unit 40, and the third displaying/operating unit 50 between a synchronous display mode and a non-synchronous display mode.

The non-synchronous display mode is operated in such a way that the first displaying/operating unit 30, the second displaying/operating unit 40, and the third displaying/operating unit 50 each individually display a signal in processing, while the synchronous display mode is operated in such a way that the first displaying/operating unit 30, the second displaying/operating unit 40, and the third displaying/operating unit 50 synchronously display a signal in processing.

The image processing section 23 provides a function of converting a signal into a color signal or a grey-scale signal to allow the first displaying/operating unit 30, the second displaying/operating unit 40, and the third displaying/operating unit 50 to individually display one of the color signal and the grey-scale signal.

After the conversion of the signal into the grey-scale signal, the image processing section 23 further provides a function of further conversion into one of mosaic or contour line to reduce the space of storage. However, since the size of data file is reduced with such an operation, the speed of uploading to cloud storage is increased. Further, a mosaic or contour line type data file offers a mechanism of protection, where the image processing section 23 must be involved in order to covert back to the grey-scale signal or the color signal. This helps prevent data from being stolen and unauthorized spreading thereby enhancing data security. Further, a user may enter and set, through the first displaying/operating unit 30, the first displaying/operating unit 40, or the first displaying/operating unit 50, at least one password to be uploaded to the cloud.

The grey-scale signal can be further converted by the image processing section 23 into a color signal, so that the signal can be displayed on the first displaying/operating unit 30. In the instant embodiment, the second displaying/operating unit 40 and the third displaying/operating unit 50 are both an electronic paper, where the image processing section 23 is operable to control the second displaying/operating unit 40 and the third displaying/operating unit 50 to achieve displaying in a grey scale manner and data may be accessed through the storage function of the memory unit 22. Since the grey-scale signal consumes less electrical power, the second displaying/operating unit 40 and the third displaying/operating unit 50 may display the grey-scale signal in an extended period of time, making it applicable to the field of electronic labels and electronic tickets. Further, in the synchronous mode or the non-synchronous mode, the image processing section 23 may, at the same time, perform simultaneous conversion of the signal into a color signal applied to the first displaying/operating unit 30.

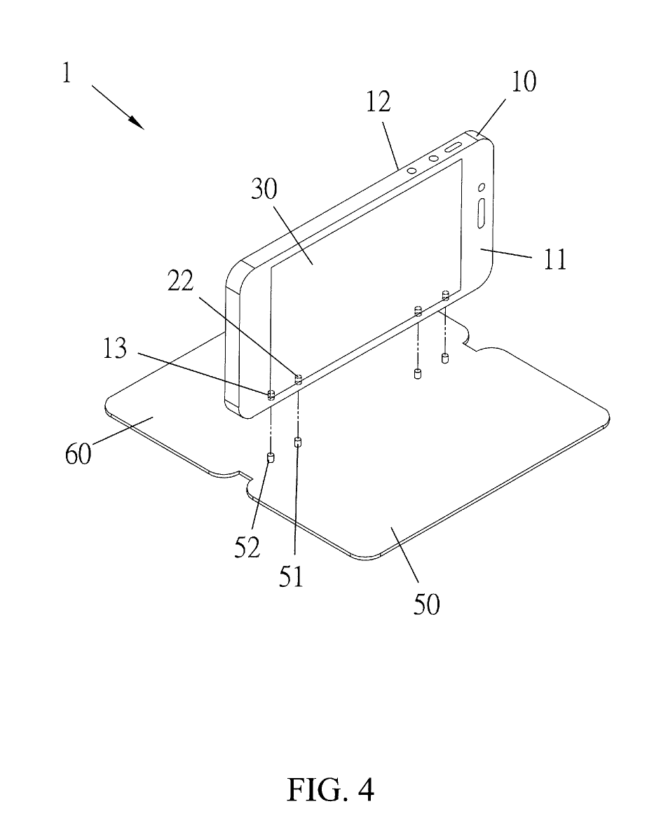

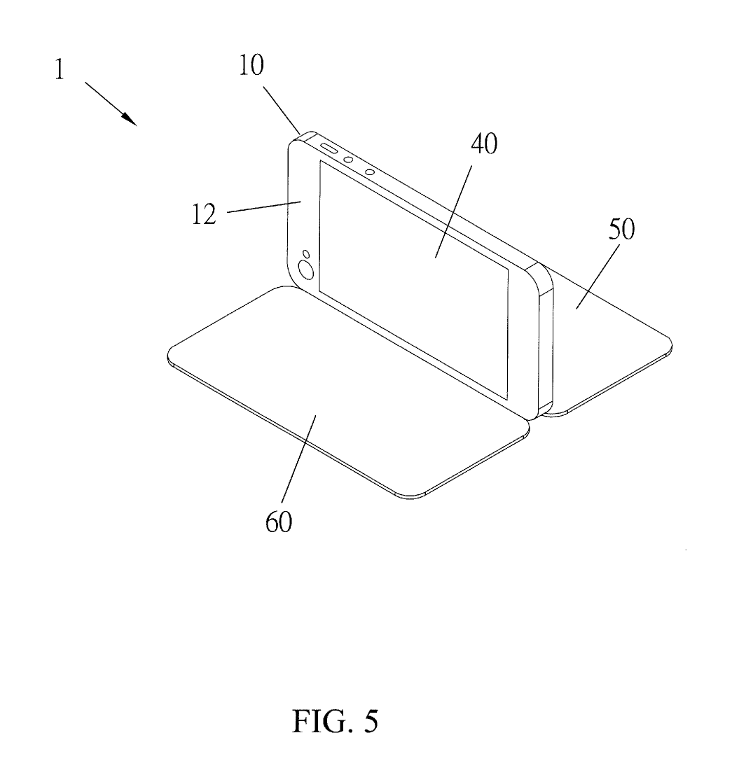

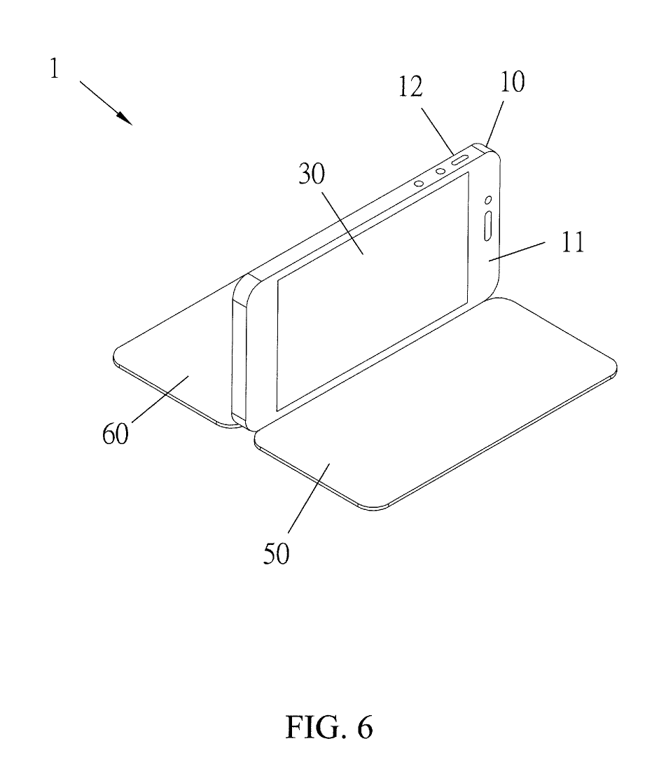

Referring to FIGS. 4-6, a second embodiment of the present invention is illustrated. In the instant embodiment, the control unit 20 comprises at least one first connection section 21 extending therefrom and arranged at one side between the front side 11 and the rear side 12. The third displaying/operating unit 50 is provided with at least one second connection section 51 electrically connectable to the first connection section 21.

The above-mentioned side between the front side 11 and the rear side 12 and the third displaying/operating unit 50 are further and respectively provided with at least one first positioning fastener 13 and at least one second positioning fastener 52 engageable with and coupleable to the first positioning fastener 13.

The first positioning fastener 13 and the second positioning fastener 52 can be female and male parts of a tenon-mortise fastener pair, a magnetically attracting fastener pair, or a snap fastener pair.

One side of the third displaying/operating unit 50 is further coupled to a fourth displaying/operating unit 60. The third displaying/operating unit and the fourth displaying/operating unit 60 are electrically connected to the control unit 20 via the second connection section 51 for displaying and operation.

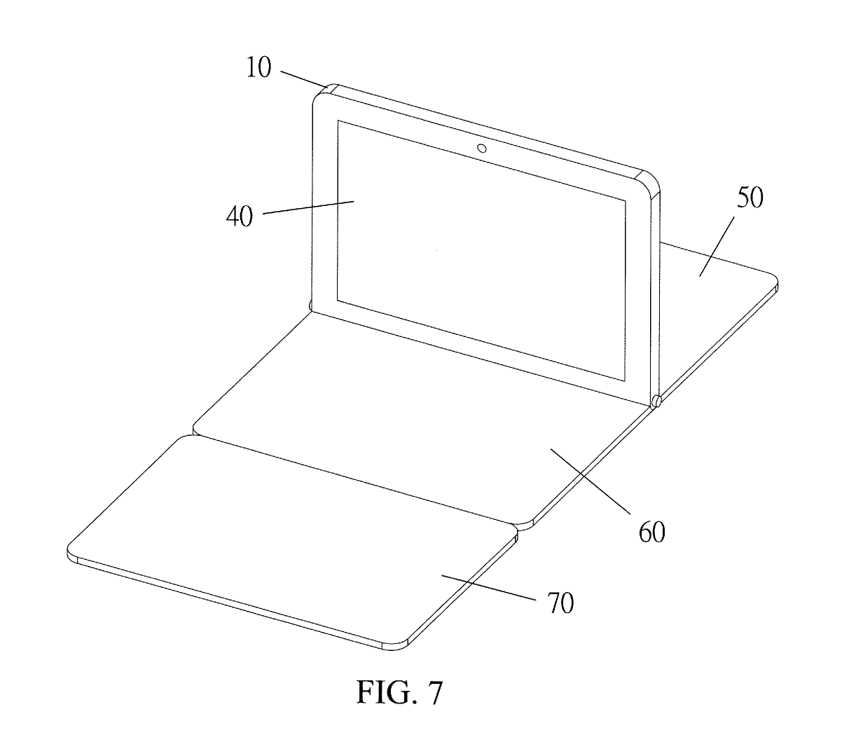

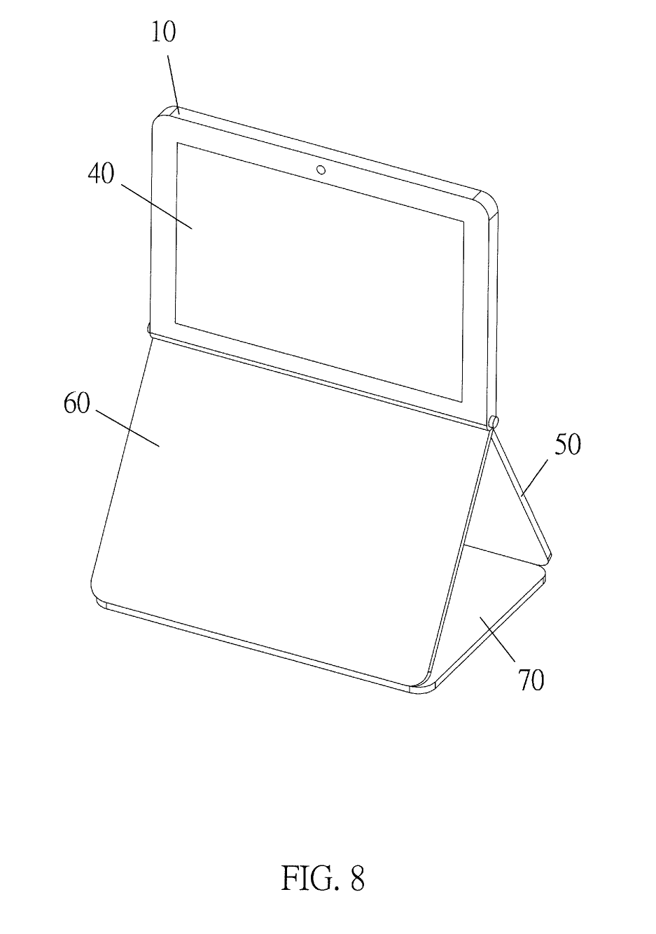

Referring to FIGS. 7 and 8, a third embodiment of the present invention is illustrated. The main body 10 is connected, in a rotatable manner, to the third displaying/operating unit 50 and the fourth displaying/operating unit 60. Further, the fourth displaying/operating unit 60 has one side to which a fifth displaying/operating unit 70 is further connected. The fifth displaying/operating unit 70 can be manipulated, through proper folding, to form a base or stand on which the main body 10, the third displaying/operating unit 50, and the fourth displaying/operating unit 60 can be supported in an erected manner, allowing for simultaneous use by a number of persons in for example the fields of conference and education.

The fifth displaying/operating unit 70 can alternatively be a board, which provides the same effect as that discussed above.

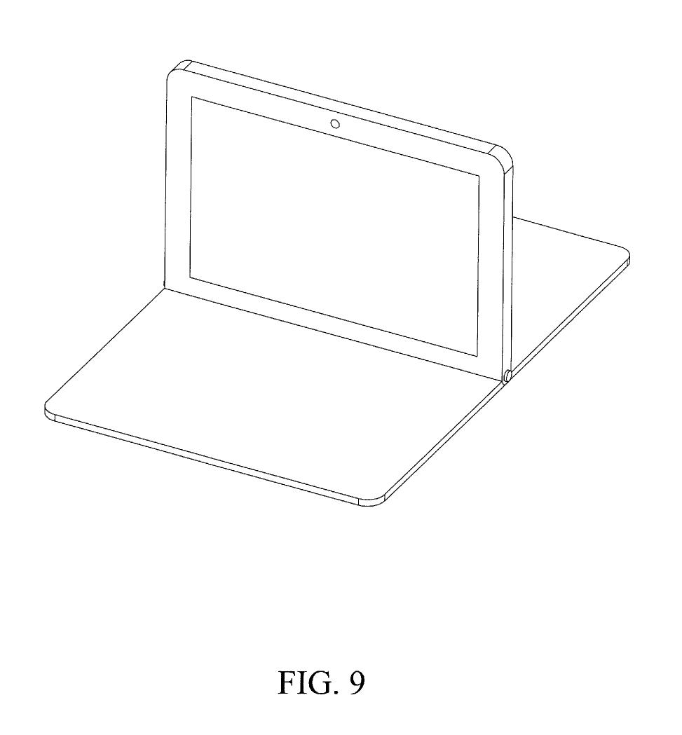

FIG. 9 is a perspective view showing another embodiment of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A front-and-rear-side or multiple-side displayable and operable smart phone/tablet computer, comprising a main body, which has a front side and a rear side respectively provided with a first displaying/operating unit and a second displaying/operating unit, and a control unit, which is arranged inside the main body and electrically connected to the first displaying/operating unit and the second displaying/operating unit for transmission of a signal and switching the first displaying/operating unit and the second displaying/operating unit between a synchronous display mode and a non-synchronous display mode, the non-synchronous display mode being such that the first displaying/operating unit and the second displaying/operating unit individually display a signal in processing and the synchronous display mode being such that the first displaying/operating unit and the second displaying/operating unit synchronously display a signal in processing, characterized in that the control unit is further electrically connected, in a detachable manner, to at least one third displaying/operating unit and the control unit further comprises an image processing section, wherein the signal, after being processed by the image processing section, enables the first displaying/operating unit, the second displaying/operating unit, and the third displaying/operating unit to individually display one of a color signal and a grey-scale signal.

2. The front-and-rear-side or multiple-side displayable and operable smart phone/tablet computer according to claim 1, wherein after the conversion of the signal into a grey-scale signal, the image processing section selectively perform a conversion into one of mosaic or contour line to reduce an amount of space required for storage.

3. The front-and-rear-side or multiple-side displayable and operable smart phone/tablet computer according to claim 1, wherein the grey-scale signal is further converted by the image processing section into a color signal.

4. The front-and-rear-side or multiple-side displayable and operable smart phone/tablet computer according to claim 1, wherein the control unit is electrically connected to a power supply and a memory unit, the power supply supplying electrical power, the memory unit storing data.

5. The front-and-rear-side or multiple-side displayable and operable smart phone/tablet computer according to claim 1, wherein the control unit comprises at least one first connection section extending therefrom and arranged at one side between the front side and the rear side and the third displaying/operating unit is provided with at least one second connection section electrically connectable to the first connection section.

6. The front-and-rear-side or multiple-side displayable and operable smart phone/tablet computer according to claim 5, wherein the side between the front side and the rear side and the third displaying/operating unit are respectively provided with at least one first positioning fastener and at least one second positioning fastener engageable with and coupleable to the first positioning fastener.

7. The front-and-rear-side or multiple-side displayable and operable smart phone/tablet computer according to claim 6, wherein the first positioning fastener and the second positioning fastener are one of a magnetically attracting fastener pair and a snap fastener pair.

8. The front-and-rear-side or multiple-side displayable and operable smart phone/tablet computer according to claim 1, wherein the main body is connected to the third displaying/operating unit in a rotatable manner.

9. The front-and-rear-side or multiple-side displayable and operable smart phone/tablet computer according to claim 1, wherein the third displaying/operating unit has one side to which at least one fourth displaying/operating unit is connected and the fourth displaying/operating unit is electrically connected to the control unit.

10. The front-and-rear-side or multiple-side displayable and operable smart phone/tablet computer according to claim 9, wherein the third displaying/operating unit and the fourth displaying/operating unit are each an electronic paper.

11. The front-and-rear-side or multiple-side displayable and operable smart phone/tablet computer according to claim 2, wherein the grey-scale signal is further converted by the image processing section into a color signal.

12. The front-and-rear-side or multiple-side displayable and operable smart phone/tablet computer according to claim 4, wherein the control unit comprises at least one first connection section extending therefrom and arranged at one side between the front side and the rear side and the third displaying/operating unit is provided with at least one second connection section electrically connectable to the first connection section.

13. The front-and-rear-side or multiple-side displayable and operable smart phone/tablet computer according to claim 12, wherein the side between the front side and the rear side and the third displaying/operating unit are respectively provided with at least one first positioning fastener and at least one second positioning fastener engageable with and coupleable to the first positioning fastener.

14. The front-and-rear-side or multiple-side displayable and operable smart phone/tablet computer according to claim 13, wherein the first positioning fastener and the second positioning fastener are one of a magnetically attracting fastener pair and a snap fastener pair.
